(19) United States
(12) Patent Application Publication
(10) Pub. No.: US 2026/0049000 A1
(43) Pub. Date: Feb. 19, 2026

(54) METHOD FOR PREPARING HIGH-PURITY VANADIUM CHEMICALS FROM VANADIUM RAW MATERIALS HAVING HIGH MOLYBDENUM CONTENTS

(71) Applicant: GfE Metalle und Materialien GmbH, Nürnberg (DE)

(72) Inventors: Thomas WITTMANN, Cadolzburg (DE); Matthias RADKE, Nürnberg (DE); Thomas BEYER, Neustadt a. d. Aisch (DE)

(21) Appl. No.: 19/102,922

(22) PCT Filed: Aug. 29, 2022
(86) PCT No.: PCT/EP2022/073954

§ 371 Date: Feb. 11, 2025

(51) Int. Cl. C01G 31/02; C01G 39/02

(52) U.S. Cl. CPC C01G 31/02; C01G 39/02; C01P 2006/80

(57) ABSTRACT

A process produces high-purity vanadium chemicals from vanadium raw materials having high molybdenum contents. Molybdenum is selectively precipitated via vanadium from alkaline vanadate solutions using the following process steps: providing a molybdenum-containing alkaline vanadate solution, adding calcium hydroxide as a precipitant in portions while keeping the pH constant between 6 and 7 using acid, mixing the solution, solid-liquid separation of the resulting suspension, and further processing the low-molybdenum alkaline vanadate solution to produce a high-purity vanadium chemical having a molybdenum content of at most 500 ppm.

### CROSS REFERENCE TO RELATED APPLICATIONS

This application is a United States National Phase Application of International Application PCT/EP2022/07395, filed Aug. 29, 2022, the entire contents of which are incorporated herein by reference.

### TECHNICAL FIELD

The invention relates to a process for producing high-purity vanadium chemicals from vanadium raw materials having high molybdenum contents.

### BACKGROUND

As regards the background of the invention, it should be noted that its aim is to develop a chemical separation process for selectively extracting molybdenum from alkaline vanadate solutions, in particular from sodium vanadate solutions having high neutral salt contents. This process is to be used prior to the precipitation of vanadium, so as to be able to use vanadium raw materials having high molybdenum contents for producing high-purity vanadium chemicals. These high-purity vanadium chemicals meet the requirements for use in the catalyst and aviation industries as well as energy storage material.

The raw materials used for this purpose may be spent catalysts and gasification residues from the petrochemical industry.

There is a need for a separation process of this type because molybdenum is leached from the aforementioned raw materials at the same efficiency as vanadium and is precipitated in part together with vanadium. If the vanadium precipitation takes place before the molybdenum precipitation, then the higher the molybdenum content in the raw material, the more the vanadium chemicals are contaminated with molybdenum. This makes the use of the vanadium chemicals for the above-mentioned applications impossible.

Specifically, the relevant prior art offers various techniques for extracting molybdenum from vanadate solutions, namely precipitation, ion exchange or liquid-liquid extraction—see L. Zeng, C. Y. Cheng, A literature review of the recovery of molybdenum and vanadium from spent hydrodesulphurisation catalysts, Part II: Separation and purification, Hydrometallurgie, 2009, 98, 10-20 and T. H. Nguyen, M. S. Lee, A review on the separation of molybdenum, tungsten, and vanadium from leach liquors of diverse resources by solvent extraction, Geosystem Engineering, 2016, 19, 247-259.

For example, it was only possible for molybdenum to be selectively extracted from a vanadate solution by precipitation after the vanadium content in the mother liquor had been reduced by a previous precipitation and the remaining vanadium had been reduced to tetravalent vanadium using sulphur dioxide at 80° C. to 90° C. The precipitation of molybdic acid then took place at a strong hydrochloric acid pH below 1.1—see Z. R. Llanos, G. F. Provoost, W. G. Deering, F. J. Debaene, Integrated process for the recovery of metals and fused alumina from spent catalysts, U.S. Pat. No. 5,702,500A, 1997.

From WO 2007/020338 A2, it is known first to precipitate vanadium from a purified sodium vanadate solution having 25.3 g/L molybdenum and 2.1 g/L vanadium, which has been obtained from a raw material having 9.7% molybdenum and 1.5% vanadium, at 90° C. using ammonium chloride at pH 7-8. This precipitates 1.5% molybdenum and more than 95% vanadium. Taking into account the volume of ammonium chloride solution added, a clarified solution having 18.7 g/L molybdenum and less than 0.08 g/L vanadium will ultimately arise, from which molybdenum is precipitated as calcium molybdate using a calcium chloride solution at pH 7-8 and 90° C. In the absence of any disclosure to the contrary in this publication, this amount of calcium chloride solution is obviously added all at once. If an alkaline vanadate solution which, unlike that of WO 2007/020338 A2, contains more vanadium than molybdenum is treated in the same way, a not inconsiderable amount of calcium metavanadate will precipitate in addition to calcium molybdate, despite the lower solubility of calcium molybdate set out in CN 132 1782 A. This is because, in solutions having high concentrations of various salts (such as calcium molybdate, calcium metavanadate, sodium metavanadate and sodium sulphate), the precipitation of the minority component, calcium molybdate, is kinetically inhibited as a result of the salting effect, and even completely fails to occur if the molybdenum content falls below a certain level. By contrast, the precipitation of the majority component, calcium metavanadate, is kinetically preferred despite its higher solubility, since the salting effect is less significant for components having higher concentrations. If the precipitation of the kinetically preferred calcium metavanadate is not explicitly inhibited by the reaction process, as would be the case when using the process described in WO 2007/020338 A2, the selectivity of molybdenum over vanadium is altered significantly in favour of vanadium. Therefore, more molybdenum remains in the precipitation liquor and thus detracts from the purity of the subsequent products such as ammonium metavanadate or vanadium pentoxide.

In the vanadium extraction process according to the above-mentioned CN 132 1782 A, calcium molybdate, calcium metavanadate and sodium metavanadate are present as solids in the presence of sodium sulphate as a result of the calcium roast used, before an ammonium carbonate solution is added for dissolution. This results in selective dissolution of calcium metavanadate over calcium molybdate and no selective precipitation of molybdenum from an alkaline vanadate solution. If merely the indication of the lower solubility of calcium molybdate by comparison with calcium metavanadate from CN 132 1782 A is used for selective molybdenum removal, this leads to success only for solutions whose vanadium content is significantly lower than their molybdenum content, since any competing precipitation of calcium metavanadate cannot be suppressed. By contrast, merely indicating the lower solubility of calcium molybdate by comparison with calcium metavanadate, in solutions having higher vanadium than molybdenum contents and simultaneously high neutral salt contents, does not lead to the required selective molybdenum extraction for producing high-purity vanadium chemicals. Control of the reaction kinetics is all the more necessary if solutions of this type are present.

The examples show that it is known to precipitate molybdenum from solutions from which vanadium has previously been precipitated and significantly depleted. However, going by current knowledge, there are no reports of successful selective precipitation of molybdenum from vanadate solutions having higher vanadium contents than molybdenum contents and simultaneously high neutral salt contents, in which competitive precipitation of vanadium needs to be suppressed.

In ion exchange systems, hexavalent molybdenum and pentavalent vanadium are adsorbed and eluted equally, and so no separation occurs here. This is made use of for complete purification of waste liquors and is only economically viable for low vanadium and molybdenum contents (0.1 g/L-1 g/L). By means of ion exchange, molybdenum is only effectively separated from tetravalent vanadium in the strongly acidic range (pH 1), and this in turn first requires the reduction of vanadium using sulphites—see L. Zeng, C. Y. Cheng, ibid.

The most widely used process for extracting molybdenum from vanadate solutions is liquid-liquid extraction—see L. Zeng, C. Y. Cheng, ibid., T. H. Nguyen, M. S. Lee, ibid., and U.S. Pat. No. 5,431,892 A. By extracting molybdenum from vanadate solutions having similar vanadium and molybdenum contents (approx. 10 g/L each), vanadium chemicals having high purities can be obtained—see U.S. Pat. No. 5,431,892 A—; however, this process is technically very complex, because of the use of organophosphorus or alkylamine-based extraction agents dissolved in organic solvents such as kerosene or xylene and the subsequent back-extraction with ammonia water, and very expensive, because of the use of special chemicals. In addition, molybdenum is extracted from these vanadate solutions in the strongly acidic, usually hydrochloric acid pH range. For example, the organophosphorus extraction agents di-(2-ethylhexyl)phosphoric acid (D2EHPA) dissolved in kerosene—see R. K. Biswas, Recovery of vanadium and molybdenum from heavy oil desulphurization waste catalyst, Hydrometallurgy, 1985, 14, 219-230—or trioctylphosphine oxide (TOPO)—see Y. A. El-Nadi, N. S. Awwad, A. A. Nayl, A comparative study of vanadium extraction by Aliquat 336 from acidic and alkaline media with application to spent catalyst, International Journal of Mineral Processing, 2009, 92, 115-120—may be used, which separate cationic molybdenum from vanadium species at pH<1. Molybdenum must then be separated using ammonia water. If D2EHPA is used, a second organic phase may form as a result of an increase in viscosity, and makes it difficult to reuse the extraction agent—see P. Zhang, K. Inoue, Recovery of metal values from spent hydrodesulfurization catalysts by liquid-liquid extraction, Energy & Fuels, 1995, 9, 231-239. Higher amines such as trioctylamine (TOA), alamin 336 dissolved in toluene—see M. A. Olazabal, M. M. Orive, L. A. Fernandez, J. M. Madariaga, Selective extraction of vanadium (V) from solutions containing molybdenum (VI) By Ammonium Salts Dissolved In Toluene, Solvent Extraction and Ion Exchange, 1992, 10, 623-635—or TOA in combination with tributyl phosphate (TBP)—see H. I. Kim, K. W. Lee, D. Mishra, K. M. Yi, J. H. Hong, M. K. Jun, H. K. Park, Separation and recovery of vanadium from leached solution of spent residue hydrodesulfurization (RHDS) catalyst using solvent extraction, Journal of Industrial and Engineering Chemistry, 2014, 20, 4457-4462—extract molybdenum at pH<1 only via tetravalent vanadium species, which must first be prepared using sulphites or sulphur dioxide.

What all these known extraction processes have in common is that the vanadium contents in the solutions to be treated are similar to or lower than the high molybdenum contents (usually <1 g/L vanadium and 1-10 g/L molybdenum).

### SUMMARY

The object of the invention is to provide a simpler, environmentally friendly yet highly effective process for selectively extracting molybdenum from alkaline vanadate solutions having, in particular, high molybdenum contents and by contrast even higher vanadium contents and simultaneously high neutral salt contents to produce high-purity vanadium chemicals.

This object is achieved by a process having the features of claim 1, in that molybdenum is selectively precipitated via vanadium from alkaline vanadate solutions by applying the following process steps:
providing a molybdenum-containing alkaline vanadate solution,
adding calcium hydroxide as a precipitant in portions while keeping the pH constant between 6 and 7 using acid,
mixing the solution,
solid-liquid separation of the resulting suspension, and
further processing the low-molybdenum alkaline vanadate solution to produce a high-purity vanadium chemical having a molybdenum content of at most 500 ppm.

The process according to the invention solves the primary problem of avoiding competitive precipitation of vanadium when treating alkaline vanadate solutions having higher vanadium contents than molybdenum contents and simultaneously high neutral salt contents, by controlling the kinetics of the proceeding reactions in a defined manner and by ensuring that the correct vanadium and molybdenum species are present in solution throughout the precipitation process. The kinetics of the reaction to form calcium metavanadate are therefore controlled by adding calcium hydroxide in portions, in other words in a manner decelerated so that the thermodynamically favoured product, calcium molybdate, which is kinetically inhibited by the salting effect, is nevertheless preferentially formed (thermodynamic reaction control). For example, with rapid addition, the kinetically favoured product, calcium metavanadate, would always precipitate if there were an excess of vanadium. Adjusting the pH between the respective additions of lime prevents the precipitation reaction from drifting into the basic pH range, so that as little calcium metavanadate as possible and predominantly more soluble calcium decavanadate is present, and this ultimately supports the selective precipitation of calcium molybdate. In addition, the lower pH limit should also be controlled as a result of the equilibrium shift between molybdate and heptamolybdate. Drifting below pH 6.2 is best avoided here, as otherwise the proportion of molybdate is shifted in favour of heptamolybdate. However, only the molybdate ions can form the less soluble calcium molybdate, while calcium heptamolybdate is very easily soluble. If the proportion of molybdate decreases with falling pH, the remaining molybdate is no longer precipitated because of the prevailing salting effect. As a result of the above circumstances, a pH in the range between 6.2 and 6.9 is preferable (claim 9).

Only by combining these two steps of adding calcium hydroxide in portions and keeping the pH constant are the selectivities of molybdenum over vanadium which are achieved according to the invention possible from solutions having, in particular, higher vanadium than molybdenum contents and simultaneously high neutral salt contents, and so only in this way can high-purity vanadium chemicals having a molybdenum content of at most 500 ppm be obtained.

Further preferred developments of the process according to the invention are set out in the specification.

It is particularly preferred that the molybdenum-containing alkaline vanadate solution has a temperature of at most 70° C., preferably approximately 60° C., at providing—see claim 2.

The object of the invention is basically achieved by precipitating molybdenum, for example as calcium molybdate (CaMoO₄)—see claim 3 —, from alkaline vanadate solutions having higher vanadium than molybdenum contents and simultaneously high neutral salt contents, the molybdenum content being at least 6.5 g/L and the neutral salt content, in particular the sodium sulphate content, preferably being in the range from 70 g/L to 120 g/L—see claim 4. The precipitation of molybdenum takes place before the precipitation of vanadium—see claim 5. This takes place up to a residual solubility of molybdenum of 1 g/L to 2 g/L, which guarantees the constant production of high-purity vanadium chemicals having a molybdenum content of at most 500 ppm from the above-mentioned raw materials. The use of raw materials of this type having high molybdenum contents is only possible by applying this process.

The precipitation of molybdenum as calcium molybdate is implemented in an aqueous medium without the addition of organic auxiliary substances—see claim 7—by incrementally adding an amount of calcium hydroxide which is stoichiometric with respect to molybdenum—see claim 6. The pH can be kept constant by metering sulphuric acid in portions—see claim 8. Under the conditions mentioned, molybdenum is precipitated via vanadium at a selectivity of 85% to 90%, which is expressed by the molar molybdenum/vanadium ratio in calcium molybdate of 85:15 to 90:10. Precipitation of poorly soluble calcium sulphate is negligible. The achievable purities of the calcium molybdate allow it to be sold as a product in the molybdenum industry.

This process according to the invention thus makes it possible to produce the aforementioned high-purity vanadium chemicals from vanadium raw materials having high molybdenum contents, such as spent catalysts, preferably vanadium-containing Ni—Mo catalysts, or vanadium-containing residues from petroleum refineries—see claim 10.

A definitive advantage of the invention over the prior art is that molybdenum can be selectively extracted, by precipitation as calcium molybdate, from alkaline vanadate solutions having significantly higher vanadium contents (approx. 35 g/L-50 g/L) than molybdenum contents (approx. 7 g/L-10 g/L) and simultaneously high neutral salt contents. According to the invention, the precipitation of molybdenum can take place before the precipitation of vanadium, so that the molybdenum content is already constantly reduced to a low level (1 g/L to 2 g/L) in the mother liquor for the subsequent precipitation of ammonium metavanadate (AMV). As a result—and again unlike in the prior art—the production of high-purity vanadium chemicals having a molybdenum content of at most 500 ppm from raw materials having high molybdenum contents is made possible by a molybdenum precipitation reaction as a purification step.

By using the process according to the invention, the ion exchange process and liquid-liquid extraction can be avoided, and this constitutes an additional economic, safety and environmental advantage as an additional delimitation from the prior art. Molybdenum is precipitated as calcium molybdate from alkaline vanadate solutions exclusively in an aqueous medium and in the mildly acidic to neutral pH range of 6 to 7, which is gentle on the system. Only inexpensive, non-toxic calcium hydroxide, which is unobjectionable in terms of occupational safety and the environment, and small amounts of sulphuric acid are used in the present invention. In addition, if calcium hydroxide is used there is no problematic contamination of the high-purity vanadium chemicals with chloride ions, as would be the case if calcium chloride were used. The possibility of cross-contamination of the vanadium chemicals and wastewater streams with organic substances is excluded. Chemical-intensive pH jumps and oxidation or reduction processes are eliminated when using this process. Likewise, complex extraction and stripping processes or units can be dispensed with; only a heatable stirring tank is required. In addition, the CaMoO₄ precipitation at approximately 60° C. requires less energy than, for example, the precipitation of molybdic acid at 80° C. to 90° C. and the precipitation of calcium molybdate at 90° C. reported in WO 2007/020338 A2. The temperature range of approximately 60° C. preferred according to the invention may be between 58 and 62° C.

### DESCRIPTION OF PREFERRED EMBODIMENTS

Further features, details and advantages of the invention will be apparent from the following description of embodiments.

### Example 1

In this example, 1 litre of a sodium vanadate solution (NaV solution) is obtained by leaching from a roasted Ni—Mo catalyst with 18.7% V and 2.4% Mo. The NaV solution, which contains 8.5 g/L molybdenum, 42.8 g/L vanadium and 105 g/L sodium sulphate, was heated to 60° C. A total of 6.55 g calcium hydroxide (anhydrous) was then added, which was stoichiometric with respect to molybdenum. Calcium hydroxide was added in four portions of 1.64 g each at intervals of 20 minutes in each case. Between the additions of the portions of calcium hydroxide, the pH was kept constant at 6.4 by slowly metering concentrated sulphuric acid (96%). After adding the last portion and adjusting the pH, the suspension was stirred at 60° C. for five hours. During the stirring time, the pH was checked and, if necessary, adjusted to 6.4 again. The precipitate was filtered and washed with water. Ammonium sulphate was added to the low-molybdenum sodium vanadate solution at a pH of 8 to 9, and this was stirred for two hours. The precipitated ammonium metavanadate (AMV) was filtered and washed with water. As an alternative to AMV, an ammonium polyvanadate (APV) or a sodium polyvanadate (NPV) can be obtained by precipitation in the pH range of 2 to 3, and a sodium ammonium vanadate (NAV) can be obtained in the pH range of 5 to 6. Vanadium pentoxide V2O5 can be routinely produced from AMV or APV by calcination in an air atmosphere, vanadium dioxide VO2 by calcination using mild reducing agents such as natural gas, or vanadium trioxide V2O3 by calcination using hydrogen. Table 1 shows the molybdenum, vanadium and sulphur contents of the sodium vanadate solution before and after molybdenum removal, the contents in the precipitate, calcium molybdate, and the contents of the ammonium metavanadates (AMV) obtained from the respective NaV solutions:

TABLE 1
Molybdenum, vanadium and sulphur contents of the NaV
solutions before and after Mo removal, of the calcium
molybdate and of the AMV without and with Mo removal.

| | NaV soln | NaV soln | | AMV | AMV |
|---|---|---|---|---|---|
| | before Mo | after Mo | Calcium | without Mo | with Mo |
| | removal | removal | molybdate | removal | removal |
| Element | g/L | g/L | % | % | % |
| Mo | 8.5 | 0.8 | 39.4 | 0.051 | 0.008 |
| V | 42.8 | 42.6 | 2.9 | 43.29 | 43.51 |
| S | 23.4 | 24.8 | 0.8 | 0.031 | 0.032 |

Example 1 shows that the NaV solution having 8.5 g/L Mo and 42.8 g/L V contains 0.8 g/L Mo and 42.6 g/L V after the described process is applied. The precipitate calcium molybdate contains Mo and V in a molar ratio of 88:12, which reflects the selectivity of the process. The AMV subsequently precipitated from the low-molybdenum NaV solution contains 0.008% Mo (corresponds to 0.010% Mo in V₂O₅, 0.011% Mo in VO₂ and 0.013% Mo in V₂O₃), the AMV without the prior molybdenum removal contains 0.051% Mo (corresponds to 0.065% Mo in V₂O₅, 0.073% Mo in VO₂ and 0.080% Mo in V₂O₃). This example shows that the inventive process of selective molybdenum removal from sodium vanadate solutions is successful and makes it possible to produce high-purity vanadium chemicals such as AMV from raw materials having high molybdenum contents (2.4% Mo). This example also shows that the precipitation of calcium molybdate is selective over a possible precipitation of calcium sulphate.

### Example 2

In this example, 1 litre of a sodium vanadate solution (NaV solution) is obtained by leaching from a roasted Ni—Mo catalyst with 13.5% V and 5.5% Mo. The NaV solution, which contains 7.9 g/L molybdenum, 36.3 g/L vanadium and 79 g/L sodium sulphate, was heated to 60° C. A total of 6.09 g calcium hydroxide (anhydrous) was then added, which was stoichiometric with respect to molybdenum. Calcium hydroxide was added in four portions of 1.52 g each at intervals of 20 minutes in each case. Between the additions of the portions of calcium hydroxide, the pH was kept constant at 6.8 by slowly metering concentrated sulphuric acid (96%). After adding the last portion and adjusting the pH, the suspension was stirred at 60° C. for five hours. During the stirring time, the pH was checked every hour and, if necessary, adjusted to 7.0 again. The precipitate was filtered and washed with water. Ammonium sulphate was added to the low-molybdenum sodium vanadate solution at a pH of 8 to 9, and this was stirred for two hours. The precipitated ammonium metavanadate (AMV) was filtered and washed with water. As an alternative to AMV, precipitation in the pH range of 2 to 3 can yield an ammonium polyvanadate (APV) or a sodium polyvanadate (NPV), and a sodium ammonium vanadate (NAV) in the pH range of 5 to 6. Vanadium pentoxide V₂O₅ can be routinely produced from AMV or APV by calcination in air atmosphere, vanadium dioxide VO₂ by calcination with mild reducing agents such as natural gas, or vanadium trioxide V₂O₃ by calcination with hydrogen.

Table 2 shows the molybdenum, vanadium and sulphur contents of the sodium vanadate solution before and after molybdenum removal, the contents in the precipitate, calcium molybdate, and the contents of the ammonium metavanadates (AMV) obtained from the respective NaV solutions:

TABLE 2
Molybdenum, vanadium and sulphur contents of the NaV
solutions before and after Mo removal, of the calcium
molybdate and of the AMV without and with Mo removal.

| | NaV soln | NaV soln | | AMV | AMV |
|---|---|---|---|---|---|
| | before Mo | after Mo | Calcium | without Mo | with Mo |
| | removal | removal | molybdate | removal | removal |
| Element | g/L | g/L | % | % | % |
| Mo | 7.9 | 2.2 | 39.1 | 0.075 | 0.009 |
| V | 36.3 | 35.9 | 4.4 | 43.19 | 43.51 |
| S | 17.7 | 19.0 | 0.7 | 0.034 | 0.011 |

Example 2 shows that the sodium vanadate solution having 7.9 g/L Mo and 36.3 g/LV contains 2.2 g/L Mo and 35.9 g/LV after the described process is applied. The precipitated product, calcium molybdate, contains Mo and V in a molar ratio of 83:17, which reflects the selectivity of the process. The AMV subsequently precipitated from the low-molybdenum sodium vanadate solution contains 0.009% Mo (corresponds to 0.012% Mo in V₂O₅; 0.013% Mo in VO₂ and 0.014% Mo in V₂O₃), while the AMV without prior molybdenum removal contains 0.075% Mo (corresponds to 0.096% Mo in V₂O₅; 0.107% Mo in VO₂ and 0.117% Mo in V₂O₃). This example shows that the inventive process of selective molybdenum removal from sodium vanadate solutions is successful and thus makes it possible to produce high-purity vanadium chemicals such as AMV from raw materials having high molybdenum contents (5.5% Mo). This example also shows that the precipitation of calcium molybdate is selective over a possible precipitation of calcium sulphate.

1. A process for producing high-purity vanadium chemicals from vanadium raw materials having high molybdenum contents, wherein molybdenum is selectively precipitated via vanadium from alkaline vanadate solutions, the process comprising the following process steps:
providing a molybdenum-containing alkaline vanadate solution;
adding calcium hydroxide as a precipitant in portions while keeping the pH constant between 6 and 7 using acid;
mixing the solution;
solid-liquid separation of the resulting suspension; and
further processing the low-molybdenum alkaline vanadate solution to produce high-purity vanadium chemical having a molybdenum content of at most 500 ppm.

2. A process according to claim 1, wherein molybdenum is precipitated in the form of one or various molybdenum-containing calcium compounds, preferably as calcium molybdate.

3. A process according to claim 1, wherein the alkaline vanadate solution provided has a higher vanadium content than molybdenum content and simultaneously a high neutral salt content, the molybdenum content being at least 6.5 g/L.

4. A process according to claim 1, wherein the precipitation of molybdenum occurs before the precipitation of vanadium from the alkaline vanadate solution.

5. A process according to claim 1, wherein calcium hydroxide is added in portions stoichiometrically with respect to molybdenum in at least four steps within a time of 90 minutes.

6. A process according to claim 1, wherein the precipitation of the molybdenum-containing calcium compound takes place in an aqueous medium without the addition of organic auxiliary substances.

7. A process according to claim 1, wherein the pH is kept constant in this range by metering sulphuric acid in portions.

8. A process according to claim 1, wherein the pH is kept constant in a range from 6.2 to 6.9.

9. A process according to claim 1, wherein the vanadium raw materials having high molybdenum contents are spent catalysts, preferably vanadium-containing Ni—Mo catalysts, or vanadium-containing residues from petroleum refineries.

10. A process according to claim 1, wherein the molybdenum-containing alkaline vanadate solution has a temperature of at most 70° C.

11. A process according to claim 10, wherein molybdenum is precipitated in the form of one or various molybdenum-containing calcium compounds, preferably as calcium molybdate.

12. A process according to claim 11, wherein the alkaline vanadate solution provided has a higher vanadium content than molybdenum content and simultaneously a high neutral salt content, the molybdenum content being at least 6.5 g/L.

13. A process according to claim 10, wherein the precipitation of molybdenum occurs before the precipitation of vanadium from the alkaline vanadate solution.

14. A process according to claim 10, wherein calcium hydroxide is added in portions stoichiometrically with respect to molybdenum in at least four steps within a time of 90 minutes.

15. A process according to claim 10, wherein the precipitation of the molybdenum-containing calcium compound takes place in an aqueous medium without the addition of organic auxiliary substances.

16. A process according to claim 10, wherein the pH is kept constant in this range by metering sulphuric acid in portions.

17. A process according to claim 10, wherein the pH is kept constant in a range from 6.2 to 6.9.

18. A process according to claim 10, wherein the vanadium raw materials having high molybdenum contents are spent catalysts, preferably vanadium-containing Ni—Mo catalysts, or vanadium-containing residues from petroleum refineries.

19. A process according to claim 1, wherein the molybdenum-containing alkaline vanadate solution has a temperature of at most 60° C.

20. A process according to claim 10, wherein the molybdenum-containing alkaline vanadate solution has a temperature of at most 60° C.
